(19) United States
(12) Patent Application Publication
(10) Pub. No.: US 2026/0111925 A1
(43) Pub. Date: Apr. 23, 2026

(54) APPARATUS AND METHOD FOR SUPPORTING REWARD PROVISION SERVICE BASED ON REAL-TIME LOCATION USING VIRTUAL PETS

(71) Applicant: Univer Inc., Incheon (KR)

(72) Inventor: TAEWAN KIM, SEOUL (KR)

(21) Appl. No.: 19/337,118

(22) Filed: Sep. 23, 2025

(30) Foreign Application Priority Data
Oct. 18, 2024 (KR) 10-2024-0142931

(51) Int. Cl. G06Q 30/0207; A63F 13/216; A63F 13/533; A63F 13/69

(52) U.S. Cl. CPC G06Q 30/0209; A63F 13/216; A63F 13/533; A63F 13/69

(57) ABSTRACT

An apparatus for supporting a real-time location-based reward provision service is configured to provide reward information for each of at least one specific location where a reward event is conducted within a predetermined radius based on location information received from each of a plurality of user terminals, the reward information being provided to a corresponding user terminal; provide a predetermined reward for the reward event to a user terminal corresponding to each user when the user moves a selected virtual pet to a desired specific location to participate in the reward event; and share reward event information in which each user is participating with other users, and assign a predetermined ability value to the first virtual pet when a cheer is received from another user regarding a movement state of a first virtual pet selected by one user to perform the reward event.

### CROSS-REFERENCE TO RELATED APPLICATION

This application claims priority to and the benefit of Korean Patent Application No. 10-2024-0142931, filed on October 18, 2024, the disclosure of which is incorporated herein by reference in its entirety.

### BACKGROUND

### Field of the Invention

Various embodiments of the present invention relate to an apparatus and method for supporting a reward provision service, and more particularly, to an apparatus and method for supporting a real-time location-based reward provision service that simultaneously satisfies interest and entertainment.

### Discussion of Related Art

In recent years, with the rapid advancement of smart device technology, various services provided through such devices have been introduced to the market. Among these, services that provide rewards based on user activities have garnered significant attention. For example, reward services that measure a user’s step count and provide points for achieving a certain number of steps have gained popularity. In particular, as interest in health and wellness increases, the demand for such services continues to grow steadily.

In this market, there is a clear trend of moving away from low-engagement services focused solely on rewards toward high-engagement services centered on entertainment and content. To this end, users are no longer satisfied with merely obtaining rewards but seek fun and immersion in the reward acquisition process. Consequently, reward applications incorporating gamified elements have become highly popular.

Alongside this, the importance of intuitive and sophisticated user interfaces (UI) and technologies that maximize the convenience of the reward acquisition process is increasingly emphasized. Therefore, there is a need to develop reward services that go beyond conventional reward systems by combining elements that stimulate user interest and provide enjoyment.

Korean Registered Patent No. 10-2071691 (Registered date: January 30, 2020) is disclosed.

### SUMMARY OF THE INVENTION

Various embodiments of the present invention aim to address the aforementioned issues by providing an apparatus and method for supporting a real-time location-based reward provision service that utilizes virtual pets to perform missions at specific locations where reward events are held.

To achieve the objectives of the present invention according to one embodiment, an apparatus for supporting a real-time location-based reward provision service includes: a memory storing at least one instruction; and a processor executing the at least one instruction. The processor is configured to provide reward information for each of at least one specific location where a reward event is conducted within a predetermined radius based on location information received from each of a plurality of user terminals, the reward information being provided to a corresponding user terminal; provide a predetermined reward for the reward event to a user terminal corresponding to each user when the user moves a selected virtual pet to a desired specific location to participate in the reward event; and share reward event information in which each user is participating with other users, and assign a predetermined ability value to the first virtual pet when a cheer is received from another user regarding a movement state of a first virtual pet selected by one user to perform the reward event.

In one embodiment, the processor may be further configured to provide a predetermined reward to another user who provided the cheer.

In one embodiment, the predetermined ability value may be variably increased as the first virtual pet receives multiple cheers from different other users.

In one embodiment, the predetermined ability value may include at least one of: an increase in movement speed that accelerates the first virtual pet’s movement to the specific location; a recovery of energy consumed by the virtual pet in performing the reward event; an increase in obstacle-overcoming ability that enhances the efficiency of performing the reward event; an increase in reward ability that allows the first virtual pet to acquire a bonus reward with a certain probability; an increase in appearance modification ability to change the first virtual pet’s appearance; an increase in decorative item acquisition ability to obtain additional decorative items for the first virtual pet; and an extension of the time limit for performing the reward event.

In one embodiment, the processor may be further configured to provide a push notification to the user terminal of the one user when a cheer is received from another user, and provide information about another user who provided the cheer and the ability value assigned to the first virtual pet.

In one embodiment, the information about another user who provided the cheer may include reward event information in which another user who provided the cheer is participating and information about a second virtual pet performing the reward event, and when a reciprocal cheer is received from the one user regarding a movement state of the second virtual pet performing the reward event of another user who provided the cheer, a predetermined cooperative ability value is assigned to the first virtual pet and the second virtual pet.

In one embodiment, the predetermined cooperative ability value may be assigned differently based on a combination of types and basic ability information of the first virtual pet and the second virtual pet.

In one embodiment, the movement state of the first virtual pet may be represented by a plurality of distinct state information based on at least one of current remaining stamina, energy consumed in performing the reward event, remaining distance to the specific location, and required time information.

In one embodiment, a predetermined reward may be differentially provided to another user who provided the cheer according to the state information of the first virtual pet when the cheer received.

To achieve the objectives of the present invention according to another embodiment, a method for supporting a real-time location-based reward provision service includes: providing reward information for each of at least one specific location where a reward event is conducted within a predetermined radius based on location information received from each of a plurality of user terminals, the reward information being provided to a corresponding user terminal; providing a predetermined reward for the reward event to a user terminal corresponding to each user when the user moves a selected virtual pet to a desired specific location to participate in the reward event; and sharing reward event information in which each user is participating with other users, and assigning a predetermined ability value to the first virtual pet when a cheer is received from another user regarding a movement state of a first virtual pet selected by one user to perform the reward event.

As described above, various embodiments of the present invention enable users to select virtual pets and move them to specific locations to participate in reward events, thereby promoting user interaction, increasing immersion in the service, and assigning predetermined ability values as users cheer or participate, which enhances the reward service and increases the number of subscribers.

Furthermore, various embodiments of the present invention promote community formation by allowing users to cheer for other users’ reward events, thereby enhancing positive interactions among users.

Additionally, various embodiments of the present invention enhance gamification and entertainment through various ability assignments and reward systems, encouraging users to stay engaged with the reward service for longer periods. By varying rewards based on cheers received from other users, the service provides continuous motivation to users, encouraging participation.

Moreover, various embodiments of the present invention enable cooperation and competition among users by sharing reward event information with other users, facilitating more active event participation.

Additionally, various embodiments of the present invention provide a more personalized reward service and enhance user experience based on collected user location information and cheer data.

Furthermore, various embodiments of the present invention enrich and diversify user experience by providing rewards differentially based on the movement state of virtual pets, encouraging continuous participation in the service through various events and reward systems, and promoting long-term use of the reward service.

The effects of the present invention are not limited to those mentioned above, and other effects not mentioned will be clearly understood by those skilled in the art from the following description.

### BRIEF DESCRIPTION OF THE DRAWINGS

FIG. 1 is a schematic diagram illustrating a real-time location-based reward provision service support system according to an embodiment of the present disclosure.

FIG. 2 is a flowchart exemplarily illustrating a method for supporting a real-time location-based reward provision service performed in a real-time location-based reward provision service support system according to an embodiment of the present disclosure.

FIG. 3 is a diagram exemplarily illustrating the configuration of a service server for supporting a real-time location-based reward provision service according to an embodiment of the present disclosure.

FIG. 4 is a flowchart exemplarily illustrating a method for supporting a real-time location-based reward provision service performed in a service server according to an embodiment of the present disclosure.

FIGS. 5 to 10 are diagrams exemplarily illustrating user interface screens of a user terminal receiving a real-time location-based reward provision service according to an embodiment of the present disclosure.

FIG. 11 is a diagram exemplarily illustrating a user interface screen of an advertiser terminal receiving a real-time location-based reward provision service according to another embodiment of the present disclosure.

FIGS. 12 and 13 are diagrams exemplarily illustrating other user interface screens of other user terminals receiving a real-time location-based reward provision service according to another embodiment of the present disclosure.

### DETAILED DESCRIPTION OF EXEMPLARY EMBODIMENTS

The advantages and features of the present disclosure, as well as the methods for achieving them, will become apparent with reference to the embodiments described in detail below in conjunction with the accompanying drawings. However, the present disclosure is not limited to the embodiments disclosed herein but may be implemented in various different forms. These embodiments are provided solely to ensure the completeness of the present disclosure and to fully inform those skilled in the art of the scope of the disclosure, which is defined only by the scope of the claims.

The terminology used in this specification is for describing the embodiments and is not intended to limit the present disclosure. In this specification, singular forms include plural forms unless specifically stated otherwise. The terms “comprises” and/or “comprising” as used in this specification do not preclude the presence or addition of one or more other components beyond those mentioned. Throughout the specification, the same reference numerals refer to the same components, and “and/or” includes each and all combinations of one or more of the mentioned components. Although terms such as “first” and “second” are used to describe various components, these components are not limited by such terms. These terms are used merely to distinguish one component from another. Accordingly, a first component mentioned below may also be a second component within the technical spirit of the present disclosure.

Unless otherwise defined, all terms used in this specification (including technical and scientific terms) may be used with meanings commonly understood by those skilled in the art to which the present disclosure pertains. Additionally, terms defined in commonly used dictionaries are not interpreted ideally or excessively unless explicitly defined otherwise.

Throughout the present disclosure, the same reference numerals refer to the same components. The present disclosure does not describe all elements of the embodiments, and general content in the technical field to which the present disclosure pertains or content overlapping between embodiments is omitted. The terms “unit” or “module” as used in this specification refer to a hardware component such as software, FPGA, or ASIC, and a “unit” or “module” performs certain roles. However, a “unit” or “module” is not limited to software or hardware. A “unit” or “module” may be configured to reside in an addressable storage medium or to execute one or more processors. Thus, as an example, a “unit” or “module” includes components such as software components, object-oriented software components, class components, and task components, as well as processes, functions, attributes, procedures, subroutines, segments of program code, drivers, firmware, microcode, circuits, data, databases, data structures, tables, arrays, and variables. The functionality provided within components and “units” or “modules” may be combined into fewer components and “units” or “modules” or further separated into additional components and “units” or “modules.”

Additionally, throughout the specification, when a part is said to “include” a certain component, it means that it may further include other components, not excluding them, unless specifically stated otherwise. Terms such as “first” and “second” are used to distinguish one component from another, and the components are not limited by these terms. Singular expressions include plural expressions unless the context clearly indicates an exception.

Meanwhile, in this specification, a “pet” refers to a preconfigured virtual character provided on a separate web page or platform by the service server (100), through which a user can perform missions on their behalf. In other words, a pet may be conceptualized as equivalent to the user on the web page or platform, or as a subordinate character or mascot owned by the user. Additionally, a pet may be a characterization of an existing living creature or a fictional creation that does not exist in reality, and a user may own at least one pet. That is, the form and number of pets are not limited.

Hereinafter, preferred embodiments of the present disclosure will be described in detail with reference to the accompanying drawings.

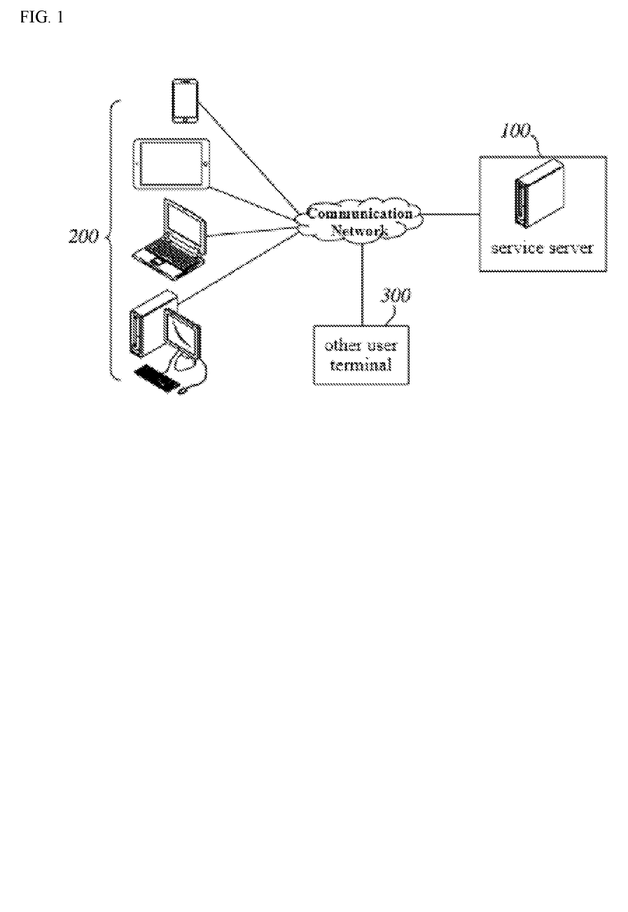

FIG. 1 is a schematic diagram illustrating a real-time location-based reward provision service support system according to an embodiment of the present disclosure.

Referring to FIG. 1, the real-time location-based reward provision service support system (hereinafter referred to as the “service support system”) according to an embodiment of the present disclosure may include a service server (100), at least one user terminal (200), and at least one other user terminal (300).

In one embodiment, the service server (100) provides a separate web page or platform (application) to enable each user to utilize the real-time location-based reward provision service, generates and provides reward information for at least one specific location based on the user’s location, and provides reward event information related to any one of the reward information in response to a service provision request from each of at least one user terminal (200), thereby enabling each user to perform the reward event and acquire a reward.

Here, the service provision request from each of the at least one user terminal (200) may be made by transmitting selection information generated based on the user’s selection from at least one piece of reward information. The selection information may include information about a specific location desired by the user, i.e., the reward event the user wishes to participate in and the entity performing the reward event.

At this time, the service server (100) confirms the user’s location based on the user’s location information, thereby displaying at least one piece of reward information within a predetermined radius from the confirmed location. That is, the service server (100) provides different reward information depending on each user’s location.

Here, the reward information may include at least one of: a reward value set to be provided for a specific location; route information including at least one available route for the user to reach the specific location; transportation means information including at least one available transportation means; mission information including at least one mission performable during or after movement; reward condition information including conditions for providing the reward; and pet information including at least one pet available for use to move to the specific location among the pets owned by the user. The conditions for providing the reward may include at least one of a time limit for restricting the time to reach the specific location and a participant limit for restricting the number of people reaching the specific location. Additionally, the at least one route may be extracted differently by considering at least one of the abilities and characteristics of each of the at least one pet.

Furthermore, the reward event information may include at least one of: route guidance information selected by the user, current location status information of the user, counted time status information, and performance status information for the at least one mission.

Meanwhile, the service server (100) provides a predetermined reward for the reward event when the user either directly moves to the desired specific location or moves a selected virtual pet to the specific location to participate in the reward event. At this time, the service server (100) may provide a higher reward when the user directly participates in the reward event compared to when the user participates using a pet, thereby motivating direct participation. However, this is merely one embodiment, and the form or extent of the reward provided is not limited.

Additionally, the service server (100) may receive service provision requests for the same reward information for a specific location from each of a plurality of user terminals (200). In this case, the service server (100) provides reward event information to each user terminal (200) and selectively or differentially provides rewards based on predetermined reward conditions. That is, since whether the user participates directly, the type/ability of the pet used, the route, and the transportation means may differ for each user, the reward event information provided to each user may differ.

Meanwhile, the reward event for the specific location may be conducted, for example, in a first-come-first-served or time attack (time trial) format. To this end, by setting a participant limit and/or a time limit as conditions for providing the reward, the service server (100) may provide or withhold rewards to each user performing the reward event based on the participant limit and/or time limit. Furthermore, rewards provided may differ depending on the number of participants and/or time, allowing different rewards to be provided to each user performing the reward event. That is, the service server (100) may selectively or differentially provide rewards.

Moreover, the service server (100) may display and provide the progress status in real-time while each user performs the reward event based on the reward event information. For example, it may display the user’s movement status, the point where the user is located on the movement route at that moment, and the like on a map. Additionally, if necessary, it may display and provide additional information such as the estimated arrival time to the specific destination location and the number of other users moving to the same specific location (participating in the same reward event).

Furthermore, the service server (100) according to one embodiment may provide reward event information (also referred to as reward event) in which each user is participating not only to the user terminal (200) but also to other user terminals (300) owned by other users, thereby sharing the reward event information with other users. When a cheer is received from another user regarding the movement state of a first virtual pet selected by an arbitrary user to perform the reward event, a predetermined ability value may be assigned to the first virtual pet. Here, the first virtual pet may be virtual pet information selected by the arbitrary user from among a plurality of virtual pets.

Here, the movement state of the first virtual pet may be information indicating various states during the process of the virtual pet moving to a specific location. For example, the various state information may include at least one of: current remaining stamina, energy consumed in performing the reward event, remaining distance to the specific location, and required time information.

In one embodiment, the at least one user terminal (200) is a terminal owned by a user who intends to use the real-time location-based reward provision service through a web page or platform provided by the service server (100). Each of the user terminals (200) can check at least one piece of reward information displayed on a map through the web page or platform and select a specific location or reward information corresponding to a reward event to be performed (participated in) by themselves or through a pet, thereby checking at least one piece of information included in the reward information.

To this end, the user terminal (200) may generate location information by checking its location at predetermined intervals and transmit it to the service server (100), or generate location information by checking its location at the moment the web page or platform is executed and transmit it to the service server (100).

Additionally, each of the at least one user terminal (200) may generate arrival information and transmit it to the service server (100) when the user reaches the specific location, thereby requesting reward provision.

Here, the arrival information may include at least one of: the time the user reached the specific location, the time taken to reach the specific location, the number of steps accumulated during movement, the movement route, the movement distance, the transportation means, and images (including images taken for verification).

In one embodiment, the at least one other user terminal (300) receives reward event information shared from the service server (100), further receives the movement of the first virtual pet of the user participating in the reward event, and if another user wishes to cheer for the movement state of the first virtual pet selected by the arbitrary user to perform the reward event, it may generate a cheer message input by the other user and transmit it to the service server (100).

At this time, since the other user terminal (300) exists within the same group, such as a friend group, including the user terminal (200), it can receive shared reward event information and the movement state of the first virtual pet of the user terminal (200) within the same friend group.

Moreover, when the at least one other user terminal (300) sends a cheer message to the corresponding user terminal (200) through the service server (100), it may receive a predetermined reward from the service server (100) as a reciprocal gesture, and the service server (100) may assign a predetermined ability value to the first virtual pet in response to the cheer message and transmit it to the corresponding user terminal (200).

Therefore, the user of the user terminal (200) can utilize the predetermined ability value assigned to the selected first virtual pet to arrive at the specific location where the reward event is held and perform the mission more quickly.

Here, the predetermined ability value may have the characteristic of being variably increased as the first virtual pet receives multiple cheers from different other users. That is, the predetermined ability value may increase and be upgraded as more cheers are received. Such predetermined ability values may include, for example, at least one of: an increase in movement speed that accelerates the virtual pet’s movement to the specific location; recovery of energy consumed by the virtual pet in performing the reward event; an increase in obstacle-overcoming ability that enhances the efficiency of performing the reward event; an increase in reward ability that allows the virtual pet to acquire a bonus reward with a certain probability; an increase in appearance modification ability to change the virtual pet’s appearance; an increase in decorative item acquisition ability to obtain additional decorative items for the virtual pet; and an extension of the time limit for performing the reward event.

Meanwhile, by providing rewards to both the user and other users, interaction between users can be promoted.

Meanwhile, FIG. 1 corresponds to one embodiment of the present disclosure. As another embodiment, the service provision system may include at least one advertiser terminal. Here, the at least one advertiser terminal is a terminal owned by an advertiser who intends to use the real-time location-based reward provision service through a web page or platform provided by the service server (100), and it receives a service somewhat different from that provided to the at least one user terminal (200) described above.

Specifically, each of the at least one advertiser terminal inputs various information to generate reward information and reward event information for a specific location designated by the advertiser through a user interface configured on the web page or platform.

At this time, the designated specific location may be at least one of: a place where a store operated by the advertiser is located, a place where an event by the advertiser is held, and a place where an advertisement by the advertiser is posted or displayed.

Accordingly, when a service provision is requested from each user terminal (200), the service server (100) generates and provides at least one piece of reward information based on the user’s location using the various information input by the at least one advertiser terminal. When selection information is received in response, the service server (100) generates and provides reward event information based on the selection information. At this time, each user terminal (200) displays at least one piece of reward information on a map through its display, and based on the at least one piece of reward information, the user can select a desired specific location, i.e., the reward event to participate in, and the entity to perform the reward event in a predetermined manner.

Meanwhile, the service server (100) according to one embodiment may generate and provide event result information to each of the at least one advertiser terminal. Here, the event result information is information including the progress results of the reward event conducted by the advertiser terminal, and may include at least one of: the age group (age group ratio) of the users who performed the reward event, whether the mission was performed (performance ratio), whether the provided reward was used (usage ratio), and information about content posted by the advertiser (including videos, images, games, etc., related to the advertiser’s products/services). If necessary, it may include visual materials such as graphs or tables.

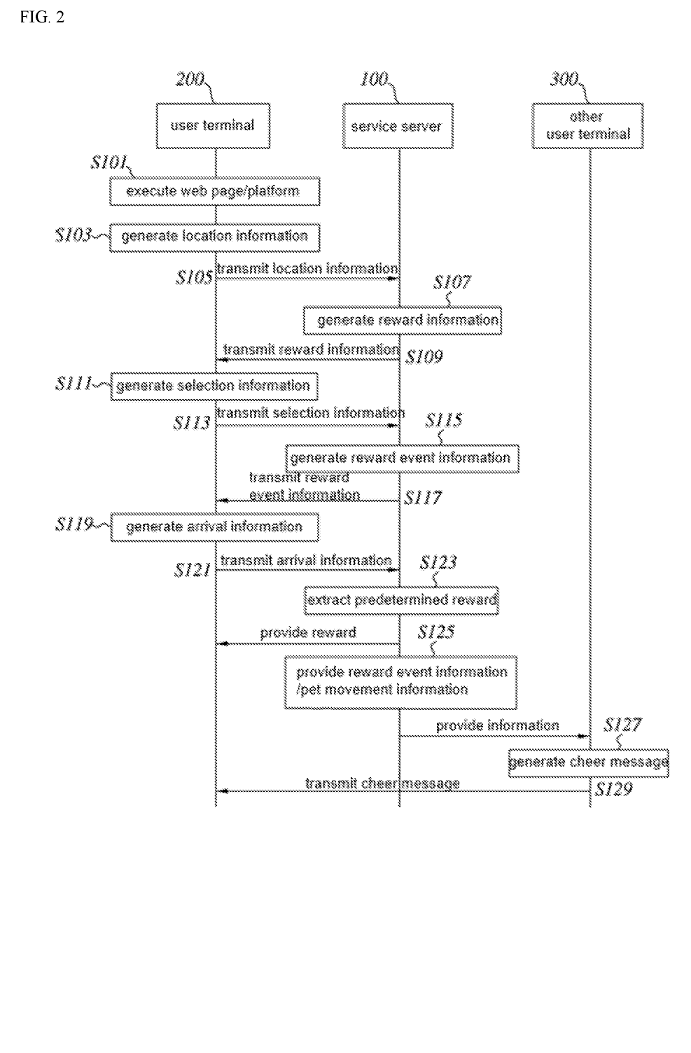

FIG. 2 is a flowchart exemplarily illustrating a method for supporting a real-time location-based reward provision service performed in a real-time location-based reward provision service support system according to an embodiment of the present disclosure. However, for convenience of explanation, only one user terminal is shown, but the operations can be performed for each of at least one user terminal (200).

Referring to FIG. 2, when the user terminal (200) executes a web page or platform provided by the service server (100), it confirms the user’s location to generate location information (S103) and transmits the generated location information to the service server (100) (S105).

Next, the service server (100) confirms reward information for each of at least one specific location where a reward event is held within a predetermined radius based on the location information received in step S105 (S107) and transmits each piece of reward information to the user terminal (200) (S109).

Next, the user terminal (200) displays and provides each piece of reward information received in step S109, thereby allowing the user to select the reward information to be performed and the entity to perform the reward event, and generates selection information based on the selection (S111).

At this time, the user terminal (200) displays specific locations where each reward event is held on a map using predetermined markers (e.g., coins, arrows) on the display. When the user selects the marker or specific location (e.g., through a touch or similar selection action), the corresponding reward information can be displayed. Additionally, the user can check various information included in the reward information to select the entity to perform the reward event. Here, the entity may be the user themselves or one of at least one virtual pet owned by the user or available to them.

Next, the user terminal (200) transmits the selection information generated in step S111 to the service server (100) (S113).

Next, the service server (100) confirms the specific location desired by the user, i.e., the reward event to participate in and the entity participating in the reward event, based on the selection information received in step S113, generates corresponding reward event information (S115), and transmits the reward event information to the user terminal (200). Accordingly, the user can check various information about the reward event to be performed through the selected entity based on the reward event information.

Next, when the entity reaches the specific location, i.e., the destination, the user terminal (200) generates arrival information (S119) and transmits the arrival information to the service server (100) to notify that it has reached the destination (S121). At this time, the arrival information may be automatically generated by the user terminal (200) recognizing the entity’s location or by the user completing a predetermined mission based on the reward event information.

Accordingly, the service server (100) extracts a predetermined reward based on the arrival information received in step S121 and the reward information mapped to the specific location and provides (delivers) it to the user terminal (200) (S123). At this time, the service server (100) may differentially provide rewards depending onewer the entity is the user or a pet, the order of arrival at the specific location, time, etc.

Next, the service server (100) may transmit (send) the generated reward event information and the movement information of the first virtual pet of the user participating in the reward event received from the user terminal (200) to the corresponding other user terminal (300) within the same friend group (S125).

At this time, it is preferable that the other user of the user is within the same friend group, but it is not necessarily limited thereto and may be an arbitrarily selected other user. Therefore, the reward event information and the movement information of the first virtual pet of the user of the user terminal (200) may be transmitted to another user terminal (300) that is not within the same friend group.

Therefore, the other user terminal (300) can generate (create) a cheer message input by the other user in response to the movement information of the first virtual pet received from the service server (100) (S127) and transmit the generated cheer message to the corresponding user terminal (200) through the service server (100) (S129).

In this process, the service server (100) can generate a predetermined ability value for the first virtual pet corresponding to the cheer message received from the other user terminal (300) (S131) and further transmit the predetermined ability value assigned to the first virtual pet to the corresponding user terminal (200) (S133).

Therefore, the user of the user terminal (200) can utilize the predetermined ability value assigned to the selected first virtual pet to arrive at the specific location where the reward event is held and perform the mission more quickly (S135). At this time, the mission may be performed not only upon arriving at the specific location but also during the process of moving to the specific location.

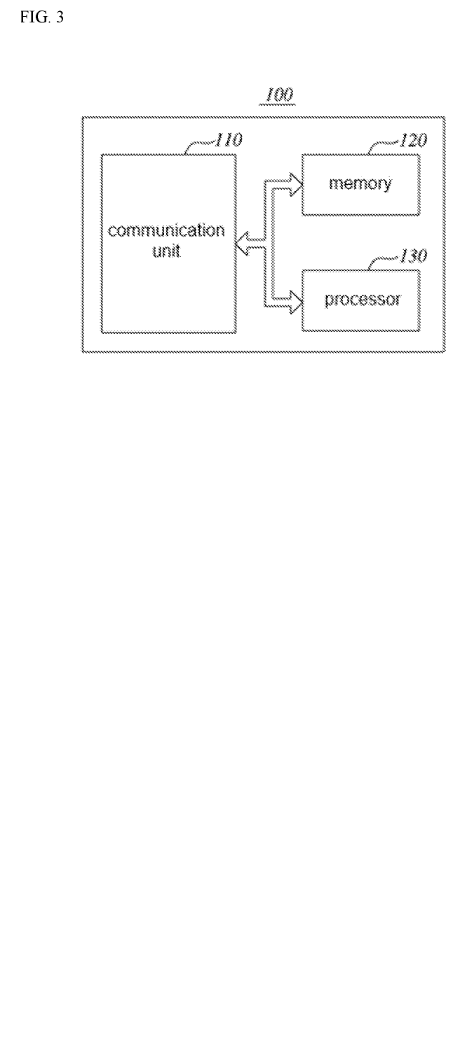

FIG. 3 is a diagram exemplarily illustrating the configuration of a service server for supporting a real-time location-based reward provision service according to an embodiment of the present disclosure.

Referring to FIG. 3, the service server (100) according to an embodiment of the present disclosure may include a communication unit (110), a memory (120), and a processor (130).

In one embodiment, the communication unit (110) can transmit and receive at least one piece of information or data between the service server (100, which may also be referred to as “at least one device”) and at least one terminal (200, 300). Here, the at least one device/terminal may be a device/terminal that intends to receive the real-time location-based reward provision service from the service server (100), and its type and form are not limited.

The communication unit (110) may also perform communication with other devices, transmitting and receiving wireless signals in a communication network based on wireless internet technologies.

Wireless internet technologies include, for example, WLAN (Wireless LAN), Wi-Fi (Wireless-Fidelity), Wi-Fi Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), and LTE-A (Long Term Evolution-Advanced). The service server (100) transmits and receives data according to at least one wireless internet technology, including those not listed above.

For short-range communication, technologies such as Bluetooth™, RFID (Radio Frequency Identification), IrDA (Infrared Data Association), UWB (Ultra-Wideband), ZigBee, NFC (Near Field Communication), Wi-Fi, Wi-Fi Direct, and Wireless USB (Wireless Universal Serial Bus) may be used to support short-range communication. Such short-range wireless communication networks (Wireless Area Networks) can support wireless communication between any two components among the service server (100), at least one user terminal (200), at least one other user terminal (300), and at least one advertiser terminal (not shown). At this time, the short-range wireless communication network may be a Wireless Personal Area Network.

In one embodiment, the memory (120) may store data for at least one process (algorithm) or a program reproducing the process for providing the real-time location-based reward provision service. Additionally, the memory (120) may further store processes for performing other operations, and this is not limited.

Meanwhile, the memory (120) may store a plurality of application programs (or applications) running on the service server (100), as well as data and instructions for the operation of the service server (100). At least some of these application programs may be downloaded from an external server via wireless communication. Meanwhile, the application programs are stored in at least one memory provided in the memory (120), installed on the service server (100), and driven by the processor (130) to perform operations (or functions) based on at least one processor stored in the memory (120).

Meanwhile, the memory (120) may include at least one memory, and the at least one memory may include a storage medium of at least one type, such as flash memory type, hard disk type, multimedia card micro type, card-type memory (e.g., SD or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, or optical disk. Additionally, the memory may store information temporarily, permanently, or semi-permanently and may be provided as a built-in or removable type.

The memory (120) may also be further linked with a separate external server.

In one embodiment, in addition to operations related to application programs, the processor (130) controls all components within the service server (100) based on at least one processor to process input or output signals, data, and information, or executes instructions, algorithms, and application programs stored in at least one memory to perform various processes, providing or processing appropriate information or functions for providing the real-time location-based reward provision service.

The processor (130) executes operations to provide a supply chain transaction information tracking service based on at least one instruction stored in the memory (120).

Specifically, by executing at least one instruction, the processor (130) confirms the user’s location based on location information received from the user terminal (200), provides reward information for each of at least one specific location where a reward event is held within a predetermined radius from the confirmed location, and provides a predetermined reward for the reward event when the user either directly moves to the desired specific location or moves a selected virtual pet to the desired specific location to participate in the reward event. At this time, the reward may be set to be provided in a greater amount (higher) when the user directly participates in the reward event compared to when the user participates using a pet.

When selection information including information about the specific location (reward event) and the entity selected by the user is received from among the reward information, the processor generates and transmits reward event information based on the selection information. As described earlier, the entity indicates the entity performing the reward event, which may be the user themselves or one of at least one pet owned by the user. At this time, each of the at least one pet may be customizable by the user terminal, equipped with paid or free items, and its ability values may be derived based on performance history information stored for previously performed reward events. That is, when each pet participates in a reward event, its performance history is recorded and stored as performance history information in the memory (120) for management.

Subsequently, when arrival information generated as the entity (the user or a pet owned by the user) performing the reward event reaches the specific location is received from the user terminal (200), the processor provides a predetermined reward to the user based on the arrival information and the reward information mapped to the specific location.

Meanwhile, when reward information is generated and provided by executing at least one instruction, the processor predicts at least one route and estimated arrival time for the user and each pet to reach the desired specific location, and may recommend the entity capable of arriving quickly and at least one route predicted for that entity, considering the estimated arrival time. That is, information may be predicted and provided regarding the route when the user directly performs the reward event, the route when each of at least one pet performs the reward event, which entity (the user or a pet owned by the user) can reach the specific location the fastest when performing the reward event, and which route is optimal. Additionally, the recommended entity and the predicted route corresponding thereto may be provided only for a certain number of routes ranked higher according to a predetermined priority (e.g., the fastest estimated arrival time).

At this time, each of the at least one pet may have its available routes predicted and recommended differently based on its unique characteristics, such as whether the pet is a bird, a fish, etc., with routes based on air, sea, or land. However, the unique characteristics of each pet may represent the characteristics of the species itself if the pet is an existing living creature, or, if the pet is a fictional creation that does not exist in reality, it may represent predetermined characteristics set for that creation.

If the user is selected as the entity, the fastest route based on at least one of air, sea, or land may be predicted through at least one of a plurality of transportation means. Meanwhile, if a pet owned by the user is selected as the entity, the available transportation means may be selected based on the pet’s characteristics, and the fastest route based on at least one of air, sea, or land may be predicted.

Here, in both the former and latter cases, a single route may be configured by combining the transportation means as well as the background of the route (e.g., air, sea, or land).

In particular, the processor (130) according to one embodiment may receive, from the corresponding user terminal (200), information about a first virtual pet selected by an arbitrary user to perform a reward event when the reward event information in which each user is participating is shared with other users, and when the first virtual pet selected by the user performs a mission at the specific location where the corresponding reward event is held, the processor may further receive the movement state of the first virtual pet generated during this process from the user terminal (200).

At this time, the movement state of the first virtual pet is represented by various state information, including current remaining stamina, energy consumed in performing the reward event, remaining distance to the target location, and required time information. For example, if the first virtual pet’s current stamina is 60%, the energy consumed in performing the reward event is 20%, the remaining distance to the target location is 200 meters, and the estimated arrival time is 25 seconds, such information may be collected and analyzed by the processor (130).

Such movement state information is shared in real-time between each user’s user terminal (200) and other user terminals (300). Thus, the processor (130) may provide the movement state information of the first virtual pet selected by the user to, for example, other user terminals (300) within the same group, and when a cheer is generated from the other user terminal (300) that has confirmed this, the processor may receive a cheer message from the other user terminal (300). This cheer message encourages the user to perform the mission more strategically based on the current state of the first virtual pet and plays an important role in motivating the user to move toward the goal.

In this case, the processor (130) may assign a predetermined ability value to the first virtual pet in response to the cheer message received from the other user terminal (300) and provide it to the corresponding user terminal (200).

At this time, the predetermined ability value may have the characteristic of being variably increased as the first virtual pet receives multiple cheers from different other users. That is, the performance of the first virtual pet selected by the user may be upgraded. In particular, the predetermined ability value may be used as a means to perform the mission more quickly or effectively through the first virtual pet selected by the user, and may also be provided to the user as a reward for attracting new users.

Such predetermined ability values may include, for example, at least one of: an increase in movement speed (step speed) that accelerates the virtual pet’s movement to the specific location; recovery of energy consumed by the virtual pet in performing the reward event; an increase in obstacle-overcoming ability that enhances the efficiency of performing the reward event; an increase in reward ability that allows the virtual pet to acquire a bonus reward with a certain probability; an increase in appearance modification ability to change the virtual pet’s appearance; an increase in decorative item acquisition ability to obtain additional decorative items for the virtual pet; and an extension of the time limit for performing the reward event.

For example, the ability value for increasing movement speed (step speed) is an ability that accelerates the movement speed of the first virtual pet to the specific location through cheers, enabling the pet to reach the target point more quickly and providing an advantage in time-limited events.

For example, the ability value for energy recovery is an ability to recover energy consumed while performing the reward event selected by the user. Since the pet’s activity may be restricted or slowed down if energy is depleted, the energy recovery ability enables mission performance over a longer period.

For example, the ability value for increasing obstacle-overcoming ability refers to the ability to effectively overcome obstacles encountered during the process of the first virtual pet reaching the specific location where the reward event is held or during the mission performed at the specific location. This allows the first virtual pet to demonstrate higher efficiency in the event performance process.

For example, the ability value for increasing decorative item acquisition ability may be an ability that allows the first virtual pet to acquire additional decorative items, where the decorative items may serve as elements to decorate the appearance of the first virtual pet or as elements to help complete missions more quickly.

For example, the ability value for extending the time limit refers to an ability to extend the time limit for missions that must be performed before or upon arriving at the specific location where the reward event is held, enabling the user to invest more time to achieve higher mission performance results.

Accordingly, the processor (130) may assign a predetermined ability value to the first virtual pet while simultaneously providing a predetermined reward to the other user terminal (300) that generated the cheer as a reciprocal gesture.

At this time, it may be preferable for the processor (130) to differentially provide a predetermined reward to the other user terminal (300) based on the state information of the first virtual pet that was cheered.

That is, the processor may adjust the type and amount of reward provided to the other user who cheered, considering the current state information of the first virtual pet. For example, if the current stamina of the first virtual pet has decreased to 50% or less, the reward provided to the other user who cheered may include items to replenish the pet’s stamina or additional energy. Conversely, if the first virtual pet maintains high stamina and movement speed, the other user who cheered may be provided with various decorative items or bonus points to enhance their incentive for participation.

Such differential rewards are effective in further motivating the participation of other users. For example, by providing more rewards to other users who actively cheer within a specific user group, it encourages mutual support and contribution to mission performance. Additionally, by appropriately adjusting the rewards provided to other users through cheers based on the user’s actions, the processor can add competitive elements and maximize interaction between users.

Meanwhile, the processor (130) according to one embodiment may provide a push notification to the corresponding user’s user terminal (200) upon receiving a cheer message from the other user terminal (300), and simultaneously provide information about the ability value assigned to the first virtual pet.

At this time, the processor (130) may further provide pre-stored information about the other user to the user terminal (200) along with the push notification. The information about the other user may include reward event information in which the other user is participating and information about a second virtual pet performing the reward event.

In other words, just as the user is participating in a reward event, the other user is also participating in their own reward event and possesses information about a second virtual pet selected to participate in that reward event.

Accordingly, the processor (130) may provide the user terminal (200) with information about the other user, including the reward event information of the other user and information about the second virtual pet performing the reward event, along with the push notification.

For example, while the user is participating in a specific event, if another user is also participating in a separate reward event, the information about the other user can be provided to the user terminal (200) simultaneously. At this time, the second virtual pet information is also information about the virtual pet selected by the other user for the corresponding event and may include the movement state of the second virtual pet.

Therefore, upon checking the reward event and second virtual pet information of the other user, the user may send a reciprocal cheer message to the other user. That is, the user terminal (200) may generate a reciprocal cheer message after checking the movement state of the second virtual pet performing the reward event of the other user.

At this time, the reciprocal cheer message is a message generated as a response (reciprocal gesture) to the cheer sent by the other user.

In this case, the processor (130) may receive the reciprocal cheer message generated from the user terminal (200), provide the reciprocal cheer message to the other user terminal (300), and simultaneously provide a predetermined reward to the user who generated the reciprocal cheer message as a reciprocal gesture.

Furthermore, the processor (130) may assign a predetermined cooperative ability value to the first virtual pet owned by the user and the second virtual pet owned by the other user in response to the reciprocal cheer message received from the user terminal (200).

At this time, the assigned cooperative ability value may be a special ability value generated by the interaction between the two virtual pets. For example, it may be an ability value where one pet shares a portion of its ability value when exerting a specific skill, or where the two pets can exert a more powerful skill together.

In other words, the mentioned cooperative ability value may be determined in the process of the two pets exchanging cheer messages while participating in the same reward event. For example, assume that the user is performing a challenge task of jumping over a specific obstacle with the first virtual pet.

At this time, if the other user sends a reciprocal cheer message while cheering, the jump ability value of the first virtual pet required to reach the specific location where the reward event is held may be temporarily improved in response to this message, allowing the pet to overcome obstacles more easily while jumping.

Simultaneously, assume that the second virtual pet of the other user who sent the cheer message is performing a challenge task of crossing water. Due to the effect of the reciprocal cheer message, the second virtual pet of the other user may have increased speed in crossing water or enhanced swimming ability.

Through such interactions, both users can achieve better results in their respective reward events, and their pets can exert stronger abilities due to the influence of cheers.

For example, the first virtual pet can save time and energy needed to overcome obstacles thanks to the other user’s cheer, while conversely, the second virtual pet of the other user can reach the destination faster by crossing water more quickly due to the reciprocal cheer. This process encourages both users to actively participate in their respective reward events and enhances interaction through reciprocal cheers.

Alternatively, the processor (130) according to one embodiment of the present disclosure may assign a predetermined cooperative ability value to the first virtual pet owned by the user and the second virtual pet owned by the other user in response to the reciprocal cheer message received from the user terminal (200), where the assigned cooperative ability value may be determined differently based on the combination of the types and basic ability information of the first and second virtual pets. This is to maximize interaction between users and the efficiency of the reward event by utilizing the characteristics of various pets.

For example, assume that the first virtual pet is a “speed-type” pet with high movement speed, and the second virtual pet is an “energy-type” pet with excellent energy recovery ability. While the user participates in a specific reward event using the speed-type pet, if the other user, who owns the energy-type pet, sends a cheer message for the event, the processor (130) may, after receiving the cheer message, increase the movement speed of the speed-type pet by 15% and enhance the energy recovery speed of the energy-type pet by 20% as a cooperative ability value. This ability value enhancement helps the user complete the reward event more efficiently and allows flexible responses to various situations that may arise during the event.

As another example, assume that the first virtual pet is an “adventure-type” pet with excellent obstacle-overcoming ability, and the second virtual pet is a “bonus-type” pet with a high probability of acquiring bonus rewards. While the user performs a challenge task of overcoming obstacles while moving to a specific location using the adventure-type pet, if the other user, who owns the bonus-type pet, sends a cheer message for the event, the processor (130) may increase the obstacle-overcoming ability of the adventure-type pet by 10% and enhance the bonus reward acquisition probability of the bonus-type pet by 25% as a cooperative ability value. This allows the user to effectively overcome more difficult obstacles while increasing the likelihood of acquiring bonus rewards.

As another example, assume that the first virtual pet is a “style-type” pet with excellent appearance modification ability, and the second virtual pet is a “time-advance-type” pet with time limit extension ability. While the user moves to a specific location using the style-type pet, if the other user, who owns the time-advance-type pet, sends a cheer message for the event, the processor (130) may increase the appearance modification speed of the style-type pet by 30% and enhance the time limit extension ability of the time-advance-type pet by 15% as a cooperative ability value. This allows the user to more effectively manage the time and resources needed during mission performance and strengthens strategic elements required for event completion.

Additionally, if the first virtual pet is a “decoration-type” pet and the second virtual pet is a pet with obstacle-overcoming ability, a cooperative ability value can be assigned even if the two pets have different characteristics. For example, if the decoration-type pet can attract the attention of other users through appearance changes, and the obstacle-type pet has the ability to effectively overcome obstacles encountered during movement, the processor (130) may increase the appearance modification speed of the decoration-type pet by 20% and enhance the obstacle-overcoming ability of the obstacle-type pet by 15% as a cooperative ability value. This allows the user to achieve higher results in the reward event by simultaneously improving visual effects and functional abilities.

As such, in this embodiment, by assigning various combinations of cooperative ability values based on the types and basic ability information of the first and second virtual pets, users can achieve optimal results in reward events depending on their pet combinations.

These cooperative ability values increase the success rate of reward events and contribute to further activating interaction between users. For example, users can strategically select the characteristics of their pets to participate more effectively in specific events, and collaboration with other users can enhance the overall efficiency of event progress. This system enriches the user experience, strengthens motivation for participating in reward events, and promotes the continuous use of the service.

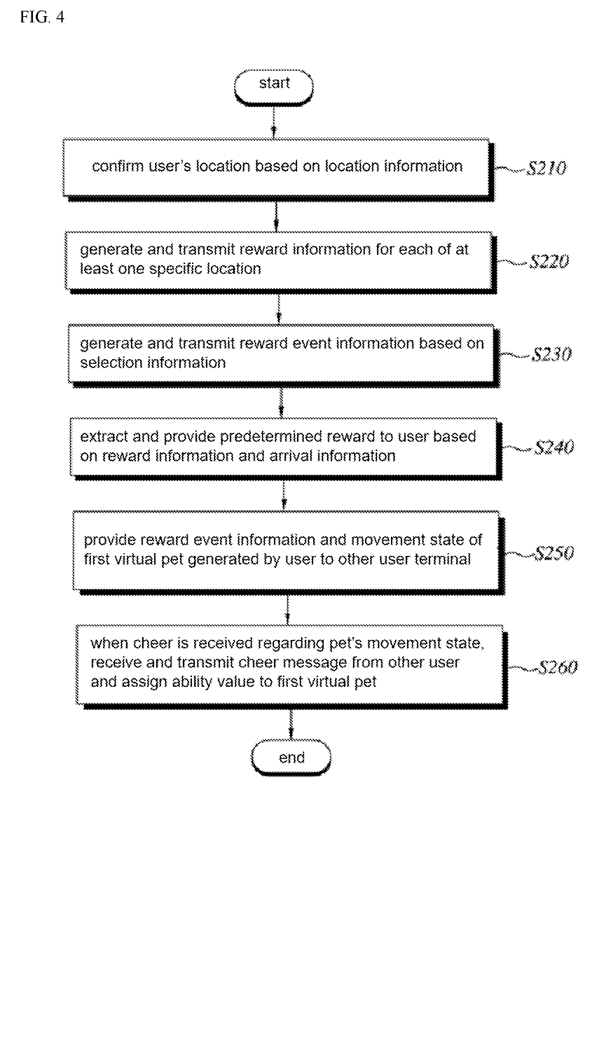

FIG. 4 is a flowchart exemplarily illustrating a method for supporting a real-time location-based reward provision service performed by a service server according to an embodiment of the present disclosure.

Referring to FIG. 4, the service server (100) confirms the user’s location based on location information received from the user terminal (200) (S210) and provides reward information for each of at least one specific location where a reward event is conducted within a predetermined radius from the confirmed location (S220).

Next, when selection information including information about the specific location (reward event) and the entity selected by the user is received based on each piece of reward information, the service server (100) generates and transmits reward event information based on the selection information (S230).

Next, when arrival information is received from the user terminal (200) as the entity selected to perform the reward event reaches the specific location (destination), the service server (100) extracts a predetermined reward based on the arrival information and the reward information mapped to the specific location and provides it to the user terminal (200) (S240).

Next, the service server (100) may provide reward event information in which each user is participating and the movement state of the first virtual pet generated by the user to the other user terminal (300) (S250), and when a cheer is received from another user regarding the movement state of the first virtual pet, the service server may receive a cheer message from the other user terminal (300), transmit it to the user terminal (200), and simultaneously assign a predetermined ability value to the first virtual pet (S260).

Meanwhile, although each step described above has been explained roughly, since the specific features and functions of each step have been sufficiently described with reference to FIG. 3 earlier, the features and functions described in FIG. 3 can be applied identically in this embodiment.

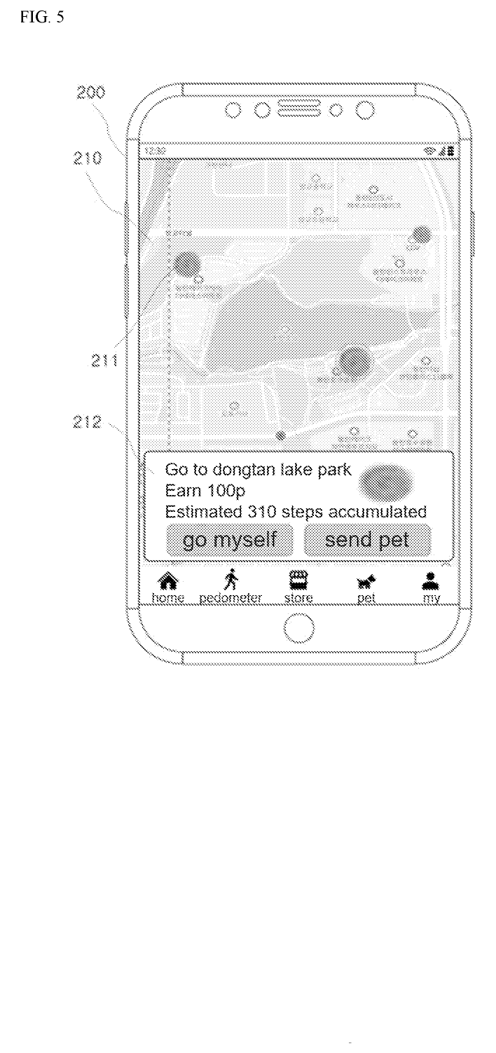

FIGS. 5 to 10 are diagrams exemplarily illustrating user interface screens of a user terminal receiving a real-time location-based reward provision service according to an embodiment of the present disclosure.

First, referring to FIG. 5, the user terminal (200) displays specific locations where each reward event is held on a map using predetermined markers (e.g., coins, arrows) (211) on the user interface screen (210). When the user selects the marker or specific location (e.g., through a touch or similar selection action), the corresponding reward information (212) can be displayed.

Additionally, the user can check the reward information to select the entity to perform the reward event. Here, the entity may be the user themselves or one of at least one pet owned by or available to the user.

However, although FIG. 5 shows only a portion of the reward information, various information included in the reward information as described earlier can be included in various forms.

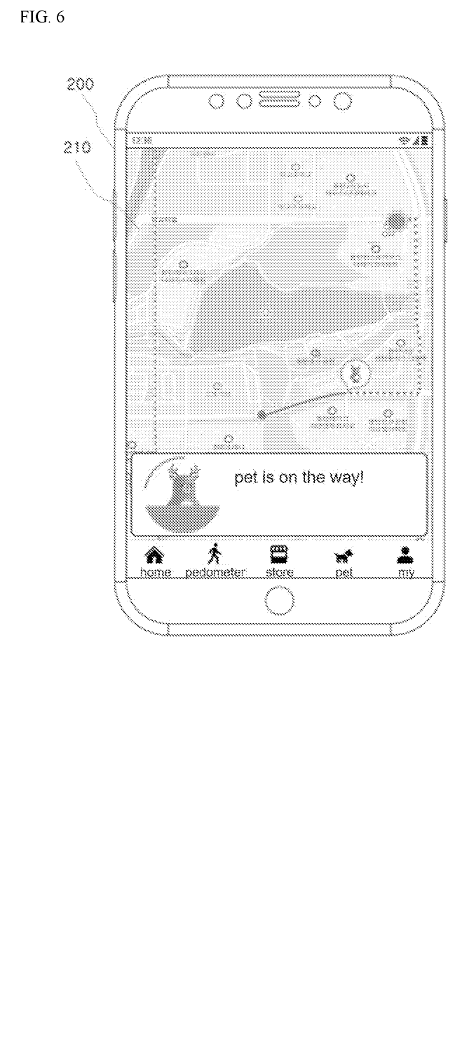

Meanwhile, referring to FIG. 6, the user terminal (200) receives reward event information about the reward event to be performed through the entity selected by the user from the service server (100) and displays and provides it on its display (210).

The reward event information may include at least one of: route guidance information selected by the user, current location status information of the user, counted time status information, and performance status information for the at least one mission.

In response to a service provision request from each of the at least one user terminal (200), reward event information related to any one of the reward information is provided, enabling each user to perform the reward event and acquire a reward.

Here, the service provision request from each of the at least one user terminal (200) may be made by transmitting selection information generated based on the user’s selection from at least one piece of reward information. The selection information may include information about the specific location desired by the user, i.e., the reward event to participate in, and the entity to perform the reward event.

Accordingly, the user can check, through the reward event information displayed on the user terminal (200), the route determined based on the selected entity (route guidance information), the status during movement (location status information), the counted status of the time limit or elapsed time (time status information), and the performance status of at least one mission set for the reward event (performance status information).

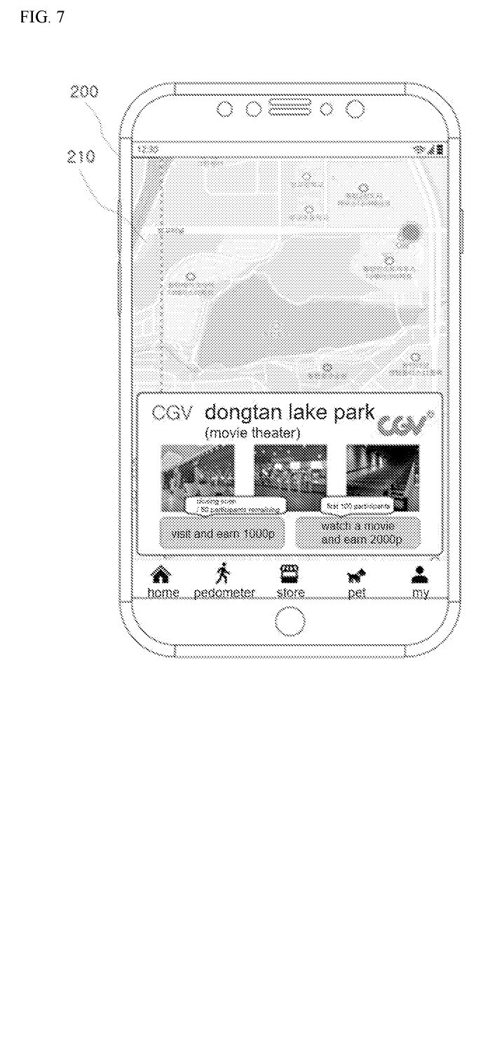

Additionally, referring to FIG. 7, when the selected entity reaches the specific location corresponding to the reward information, i.e., the destination, the user can certify the visit to notify the service server (100) of arrival at the destination. Although it is shown that this is done by touching (clicking) a button configured in a predetermined manner by the service server (100) to certify the visit, this is merely one embodiment, and the method or form of certifying the visit is not limited.

Meanwhile, as shown in FIG. 7, in addition to the mission of visiting the specific location to receive 1000P, a mission of watching a movie to receive 2000P is set, indicating that additional rewards can be provided by performing various activities that can be experienced at the specific location beyond simply visiting it.

Furthermore, as another embodiment, a predetermined item may be provided upon completing a mission for the reward event along with the reward. For example, the item may be related to the store, brand, product, or service of the advertiser hosting the reward event, including text, logos, colors, images, etc., and this item may be equipped on or displayed with the pet owned by the user. At this time, the item may be in the form of a medal, clothing, hat, watch, pet speech bubble, bag, or other items that the pet can wear or possess, or it may be in the form of a space or background displayed with the pet. Additionally, when another user selects/touches the item equipped on the user’s pet, an advertisement video or website related to the advertiser’s store, brand, product, or service may be displayed. That is, the form and utilization method of the item are not limited.

As a result, as the pet equipped with the item is active on the web page or platform, the service provider and/or advertiser can utilize the item as an advertising means, thereby achieving advertising effects and even expecting revenue generation effects.

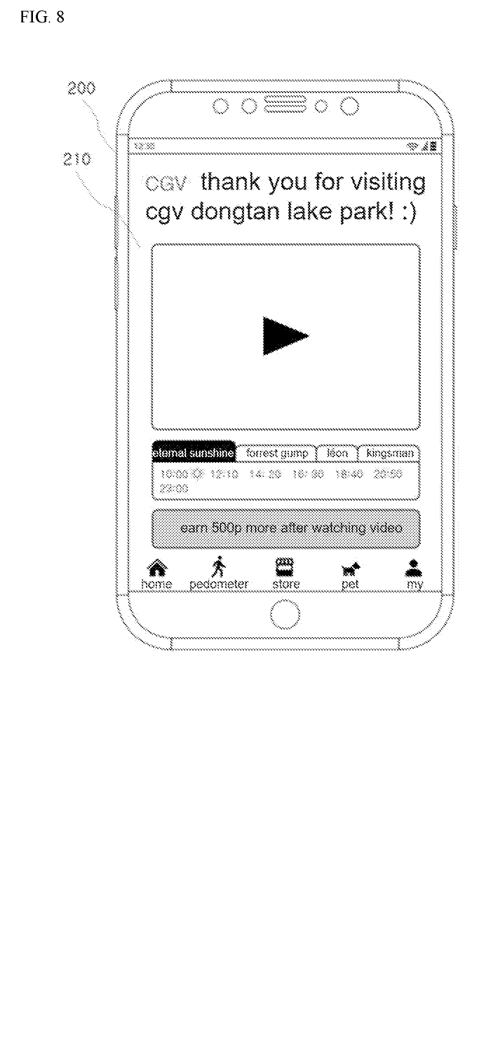

Furthermore, as shown in FIG. 8, information such as ongoing events or announcements at the specific location can be posted, and content such as advertisement videos can also be posted. This allows additional rewards to be provided by having the user watch the corresponding content.

That is, rather than ending with a single reward provision, continuous reward provision is possible by having the user perform additional actions related to the services or products provided at the specific location.

The settings for the reward can be set or changed by the service server (100) or the advertiser terminal (not shown).

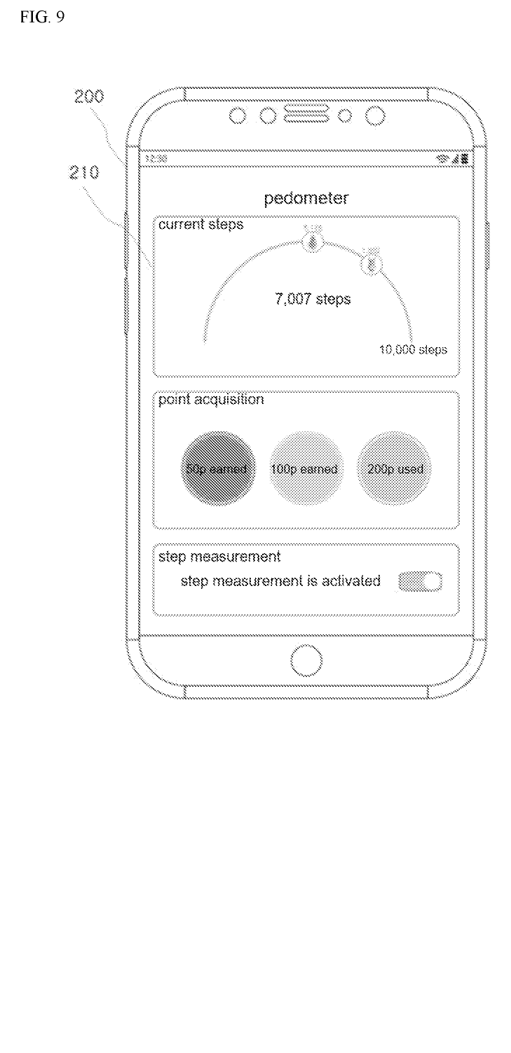

Meanwhile, as shown in FIG. 9, the user can accumulate, store, and manage data generated by performing reward events through the user terminal (200). At this time, each piece of data may be stored separately for each pet, as shown in FIG. 9.

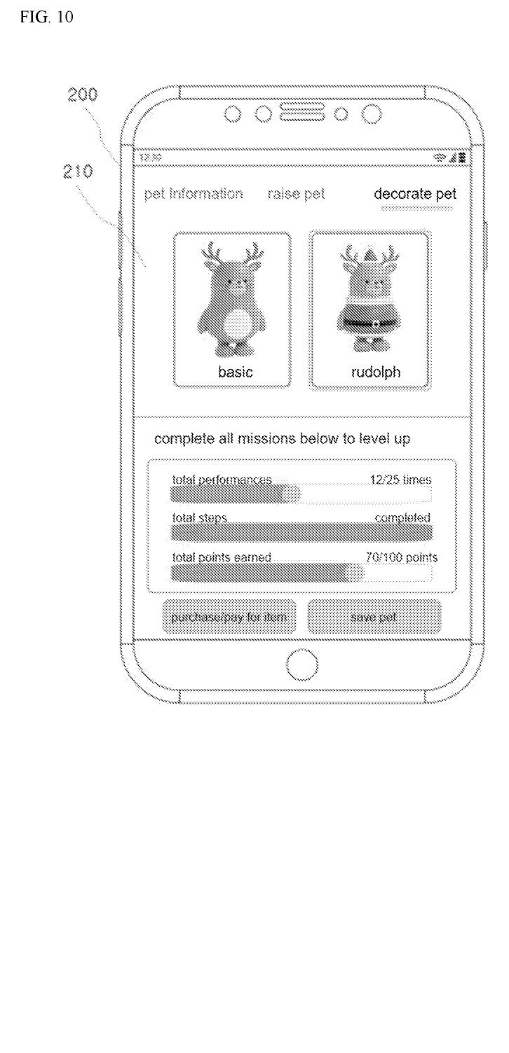

Furthermore, as shown in FIG. 10, the user can not only check at least one pet owned through the user terminal (200) but also perform customization for each pet. At this time, items can be equipped on each pet, and advertising items provided at the request of the advertiser may be provided as free items, or separate paid items may be purchased/paid for use.

Additionally, ability values may be calculated and displayed based on the performance history information for each pet.

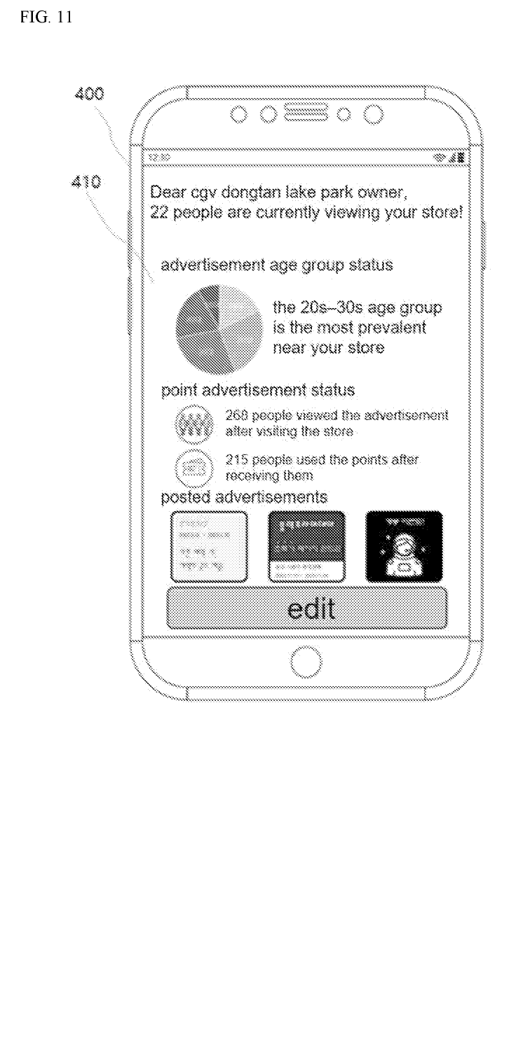

FIG. 11 is a diagram exemplarily illustrating a user interface screen of an advertiser terminal receiving a real-time location-based reward provision service according to another embodiment of the present disclosure.

Referring to FIG. 11, the advertiser can display and provide event result information on the display (410) of the advertiser terminal (400). Here, the event result information is generated at the request of the advertiser or generated at predetermined intervals and received from the service server (100), including the progress results of the reward event conducted by the advertiser terminal.

Specifically, as described earlier, it may include information about at least one of: the age group (age group ratio) of the users who performed the reward event, whether the mission was performed (performance ratio), whether the provided reward was used (usage ratio), and content posted by the advertiser (including videos, images, games, etc., related to the advertiser’s products/services). If necessary, it may include visual materials such as graphs or tables.

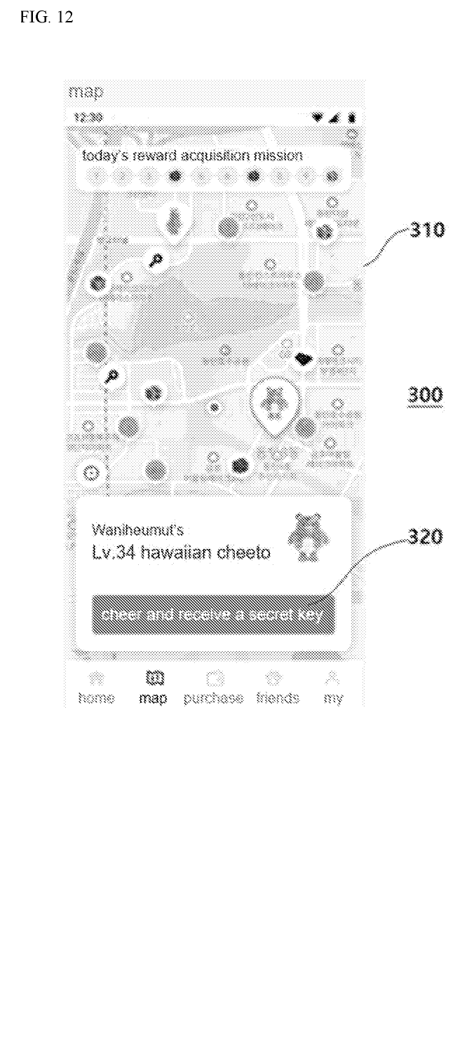

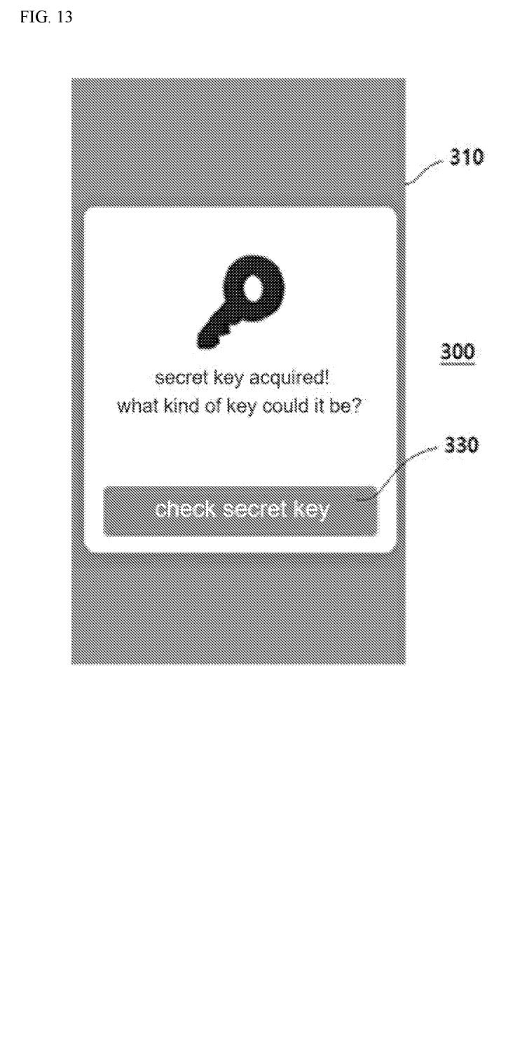

FIGS. 12 and 13 are diagrams exemplarily illustrating user interface screens of another user terminal receiving a real-time location-based reward provision service according to another embodiment of the present disclosure.

Referring to FIG. 12, when reward event information in which each user is participating is shared with other user terminals (300) within the same group according to an embodiment, the service server (100) may provide the user’s reward event information and the movement state information of the first virtual pet selected by the user to the other user terminal (300) to be displayed on the other user interface screen (310).

Accordingly, the other user can check the reward event in which the user is participating and simultaneously check the movement state information of the first virtual pet selected by the user on the other user interface screen (310). In this case, to cheer for the user’s efforts regarding the movement state of the first virtual pet, the other user can click “Cheer and Receive a Secret Key (320)” on the other user interface screen (310), and the other user terminal (300) can generate a cheer message and transmit it to the service server (100).

Accordingly, the service server (100) can assign a predetermined ability value to the user’s first virtual pet in response to the cheer message received from the other user terminal (300) and provide a reward (330) such as a secret key to the other user terminal (300) as a reciprocal gesture, as shown in FIG. 13. In this case, the other user can check and acquire the reward (330) such as a secret key on the other user interface screen (310).

At this time, the reward (330) provided to the other user terminal (300) may be an item such as a secret key, but it may also be in various forms such as points or cash, and is not necessarily limited thereto.

As shown in FIG. 13, the secret key reward (330) provided to the other user terminal (300) is displayed on the other user interface screen (310) of the other user terminal (300), allowing the other user to check it.

As described above, the functional operations of each component according to various embodiments may be implemented in the form of program instructions and recorded on a computer-readable recording medium and/or memory.

The mentioned computer-readable recording medium may include program instructions, data files, data structures, etc., alone or in combination. The program instructions recorded on the computer-readable recording medium may be specially designed and configured for the present invention or may be known and available to those skilled in the computer software field. Examples of computer-readable recording media include magnetic media such as hard disks, floppy disks, and magnetic tapes, optical recording media such as CD-ROMs and DVDs, magneto-optical media such as floptical disks, and hardware devices specially configured to store and execute program instructions, such as ROM, RAM, flash memory, etc. Examples of program instructions include not only machine code generated by a compiler but also high-level language code executable by a computer using an interpreter. The hardware device may be configured to operate as one or more software modules to perform the processing according to the present invention, and vice versa.

Accordingly, although described with specific details such as specific components according to various embodiments of the present disclosure through embodiments and drawings, this is provided only to aid in a more comprehensive understanding, and the various embodiments are not limited thereto. Those skilled in the art to which the present invention pertains can make various modifications and variations from this description.

Therefore, the spirit of the present invention should not be limited to the embodiments described above, and not only the claims described below but also all equivalents or equivalent modifications thereof belong to the scope of the spirit of the present invention.

What is claimed is:

1. An apparatus for supporting a real-time location-based reward provision service using virtual pets, comprising:
a memory configured to store at least one instruction; and
a processor configured to execute the at least one instruction, wherein
the processor is configured to:
provide reward information for each of at least one specific location where a reward event is conducted within a predetermined radius based on location information received from each of a plurality of user terminals, the reward information being provided to a corresponding user terminal;
provide a predetermined reward for the reward event to a user terminal corresponding to each user when the user moves a selected virtual pet to a desired specific location to participate in the reward event; and
share reward event information in which each user is participating with other users, and assign a predetermined ability value to the first virtual pet when a cheer is received from another user regarding a movement state of a first virtual pet selected by one user to perform the reward event.

2. The apparatus of claim 1, wherein
the processor is further configured to provide a predetermined reward to another user who provided the cheer.

3. The apparatus of claim 1, wherein
the predetermined ability value is variably increased as the first virtual pet receives multiple cheers from different other users.

4. The apparatus of claim 1, wherein
the predetermined ability value includes at least one of:
an increase in movement speed that accelerates the first virtual pet’s movement to the specific location;
a recovery of energy consumed by the virtual pet in performing the reward event;
an increase in obstacle-overcoming ability that enhances the efficiency of performing the reward event;
an increase in reward ability that allows the first virtual pet to acquire a bonus reward with a certain probability;
an increase in appearance modification ability to change the first virtual pet’s appearance;
an increase in decorative item acquisition ability to obtain additional decorative items for the first virtual pet; and
an extension of the time limit for performing the reward event.

5. The apparatus of claim 1, wherein
the processor is further configured to provide a push notification to the user terminal of the one user when a cheer is received from another user, and provide information about another user who provided the cheer and the ability value assigned to the first virtual pet.

6. The apparatus of claim 5, wherein
the information about another user who provided the cheer includes reward event information in which another user who provided the cheer is participating and information about a second virtual pet performing the reward event, and
when a reciprocal cheer is received from the one user regarding a movement state of the second virtual pet performing the reward event of another user who provided the cheer, a predetermined cooperative ability value is assigned to the first virtual pet and the second virtual pet.

7. The apparatus of claim 6, wherein
the predetermined cooperative ability value is assigned differently based on a combination of types and basic ability information of the first virtual pet and the second virtual pet.

8. The apparatus of claim 1, wherein
the movement state of the first virtual pet is represented by a plurality of distinct state information based on at least one of current remaining stamina, energy consumed in performing the reward event, remaining distance to the specific location, and required time information.

9. The apparatus of claim 8, wherein
a predetermined reward is differentially provided to another user who provided the cheer according to the state information of the first virtual pet when the cheer received.

10. A method for supporting a real-time location-based reward provision service, comprising:
providing reward information for each of at least one specific location where a reward event is conducted within a predetermined radius based on location information received from each of a plurality of user terminals, the reward information being provided to a corresponding user terminal;
providing a predetermined reward for the reward event to a user terminal corresponding to each user when the user moves a selected virtual pet to a desired specific location to participate in the reward event; and
sharing reward event information in which each user is participating with other users, and assigning a predetermined ability value to the first virtual pet when a cheer is received from another user regarding a movement state of a first virtual pet selected by one user to perform the reward event.
